(19) United States
(12) Patent Application Publication
(10) Pub. No.: US 2006/0096035 A1
(43) Pub. Date: May 11, 2006

(54) Multifunctional tool

(76) Inventor: Matthias Ocklenburg, Wuppertal (DE)

Correspondence Address: Martin A Farber, 866 United Nations Plaza, Suite 473, New York, NY, 10017, US

(21) Appl. No.: 10/497,359

(22) PCT Filed: Dec. 17, 2002
(86) PCT No.: PCT/EP02/14381

§ 371 Date: Jul. 6, 2005

(30) Foreign Application Priority Data
Dec. 19, 2001 (DE) 101 62 855.2

(51) Int. Cl. B67B 7/04; B26B 11/00; B25F 1/00

(52) U.S. Cl. 7/155; 7/118; 7/158; 81/3.45

(57) ABSTRACT

The invention relates to a multifunctional tool comprising two handle parts (5) that can be pivoted out of a parallel position in which they face one another, and comprising a tool (I) situated in the area of the pivot point (7). At least one additional tool (II) is allocated, which can pivot about an axis (8) that is assigned to the end of the handle part (5) located opposite the pivot point (7). This additional tool can be pivoted out of a folded-in stored position and into a position of use in which it is folded out by approximately 180° whereby resting against a stop. The aim of the invention is to provide a multifunctional tool that is advantageous with regard to its use. To this end, the tool (I) is a corkscrew (1) in which both handle parts (5) can pivot out of the parallel position only until reaching an extended position in which their pivotal movement is limited by a stop.

The invention relates to a multifunctional tool having two grip parts, which face one another and can be pivoted out of a parallel position, and having a tool arranged in the region of the pivot location, at least one additional tool being provided, which can be pivoted about a pin associated with the opposite end of the grip part from the pivot location and which is pivotable out of a pivoted-in stowed position into a position of use in which it is pivoted out through approximately 180° onto a stop.

A multifunctional tool of this type is known from U.S. Pat. No. 6,014,787. The tool is a pair of pliers whose ends which are remote from the jaws and are located beyond the articulation connection include the pivot location for the grip parts. The additional tools are, for example, a pair of scissors, a screwdriver, a bottle opener, etc. In the stowed position, the correspondingly folded-in additional tools, like the head of the pair of pliers, which takes up most of the space, are also accommodated in a side recess in the grip parts. The length of the recess is partly taken up by the utensils mentioned.

Proceeding from the abovementioned prior art, the object of the invention is to improve the multifunctional tool of the generic type from the handling point of view.

This object is achieved firstly and substantially in a multifunctional tool having the features of Claim 1, in which it is provided that the tool is a corkscrew and the two grip parts, from the parallel position, can only be pivoted into an extended position, with the pivoting movement being limited by stop means. This leads to a cross-grip which is optimally positioned in the hand used to hold it. By means of this cross-grip, it is possible for the tool to be applied in a controlled way and for the rotary manipulation typical of corkscrews to be carried out in a powerful way. Nevertheless, in this case too, it is possible to take account of the parallel position with a view to protecting or protected enclosure of the tool.

The subjects of the further claims are explained below with reference to the subject matter of Claim 1, but may also be of importance in their independent wording. Thus it is also proposed that the corkscrew, when the grip parts are being pivoted, be controlled so as to remain in an angle-bisecting position. This allows the formation of an increasingly large space to grip behind, which is of equal size on both sides, and avoids injury on the spiral body, which is generally to some extent configured with cutting edges on the periphery, of the corkscrew. The structural means required for this purpose are simple and stable in use. For example, the control is achieved by toothed engagement between two toothed segments, which are each associated with one of the two grip parts. The grip parts are lifted off the tool synchronously or vice versa by means of the toothed engagement. Moreover, the invention proposes that the corkscrew be an extension of a connecting web which carries the two grip parts in such a manner as to connect them to one another. An in practice shield-like connecting web of this type to this extent performs a dual function, since it is already a stable base part of the corkscrew. It is advantageous for the toothed segment to be formed at a grip shell. A further importance of the connecting web results from spring tongues which engage on the connecting web in order to retain the grip parts in the parallel and extended position. Precision control members of this type are provided with suitable guidance on the connecting web. Furthermore, a structurally advantageous feature is formed by pin sections which are associated with the connecting web and connect to one another at least two pockets, which are disposed parallel to one another, for blade leaves forming the additional tools which can be pivoted out. The grip parts of the cross-grip described above are expediently extended in lever style by these additional tools which can be pivoted out. A structurally advantageous configuration results, moreover, from securing screws screwed into the pin sections in order to fix the two grip shells. The holding-together is in this case optimized by virtue of the grip shells, at their free end, being connected to one of the blade leaves with a latching hook engagement. Moreover, latching hook engagement of this type is out of sight, making the exterior of the multifunctional tool attractive. Moreover, it is provided that each of the two grip shells forms a half-pocket, and in the parallel position of the grip parts these half-pockets complement one another to form a pocket which accommodates the corkscrew. Finally, it is also proposed that the pocket be located eccentrically. Consequently, an approximately pocket-length accommodation space also remains for the additional tools. These tools can therefore be of greater length than in the case of the precursor mentioned above. The additional tools are a pair of scissors, a file and/or a cutting blade.

The subject matter of the invention is explained in more detail below with reference to an exemplary embodiment illustrated in the drawing, in which:

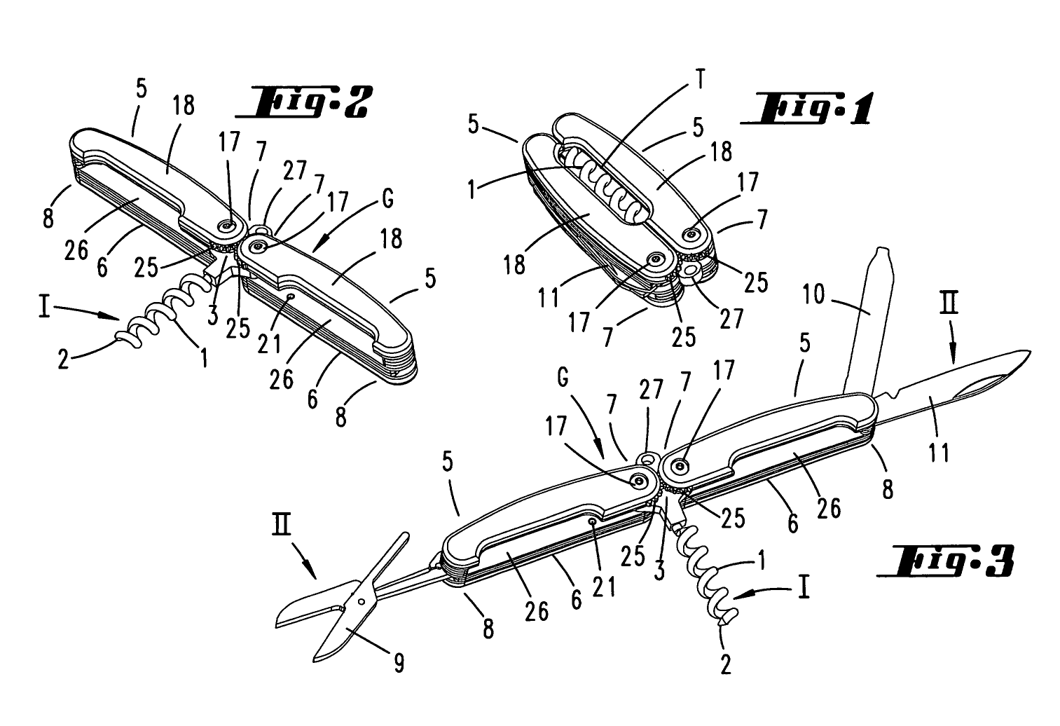

FIG. 1 shows a perspective view of the multifunctional tool in its space-saving, closed position,

FIG. 2 shows a perspective view of the multifunctional tool in its folded-out position, forming a cross-grip with a corkscrew protruding freely as a tool,

FIG. 3 shows an illustration corresponding to that shown in FIG. 2, but with additional tools pivoted out, with the pivoting movement limited by stop means, so as to form extending sections of the cross-grip,

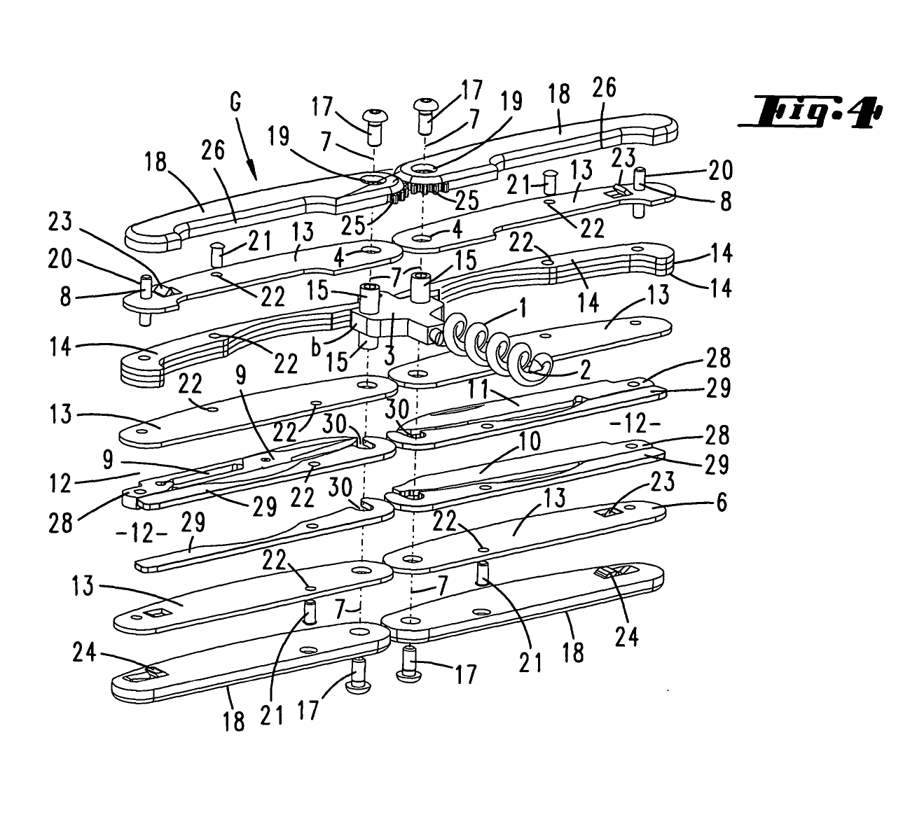

FIG. 4 shows an exploded illustration, once again in diagrammatic form, of the multifunctional tool in its position of use as shown in FIG. 2,

FIG. 5 shows a front view of the multifunctional tool in its closed position,

FIG. 6 shows a side view from the right-hand side,

FIG. 7 shows a side view from the left-hand side,

FIG. 8 shows a back view of the multifunctional tool,

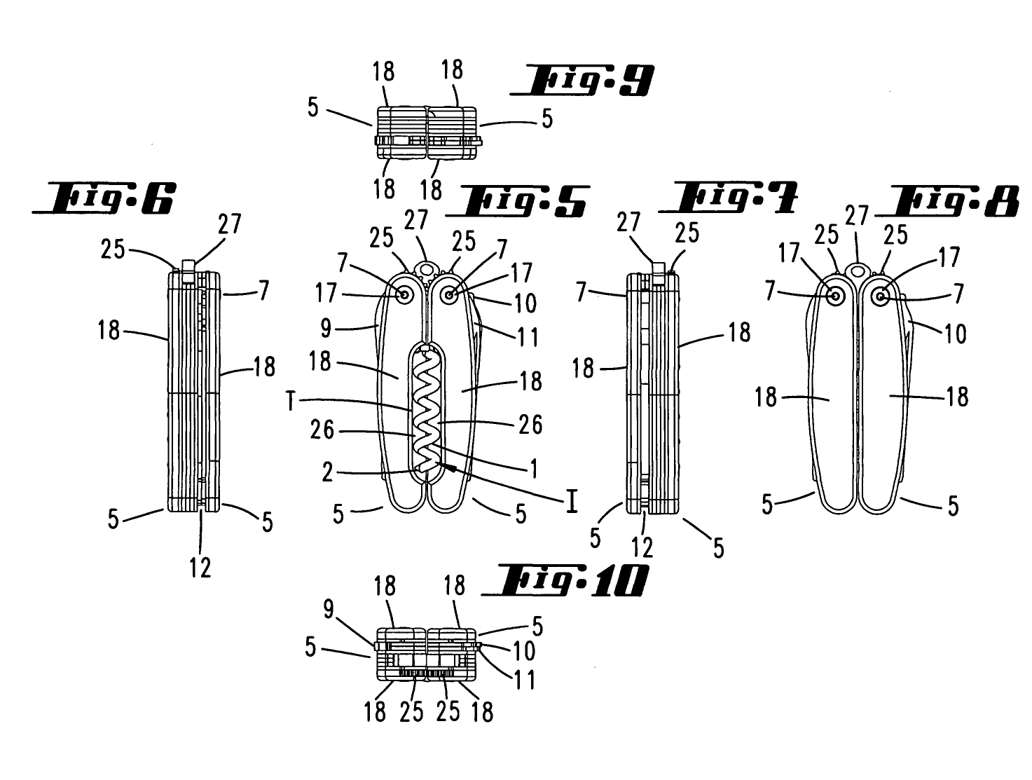

FIG. 9 shows a view from below,

FIG. 10 shows a view from above,

FIG. 11 shows a front view of the multifunctional tool, in the folded-out position,

FIG. 12 shows a side view from the right-hand side,

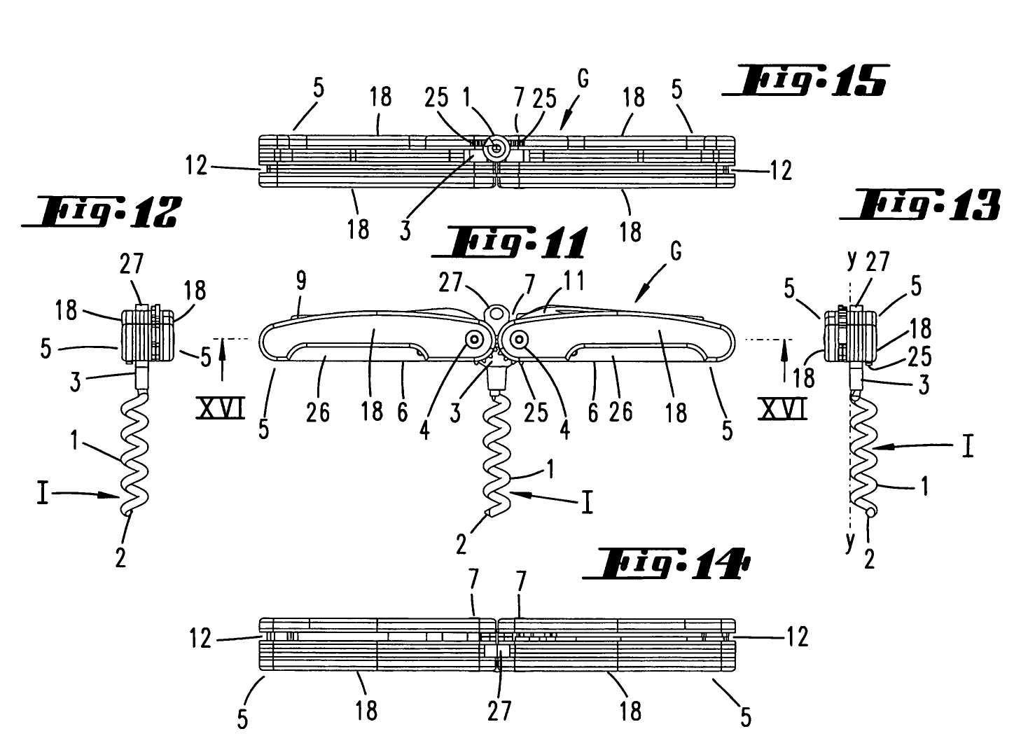

FIG. 13 shows a side view from the left-hand side,

FIG. 14 shows a view from below,

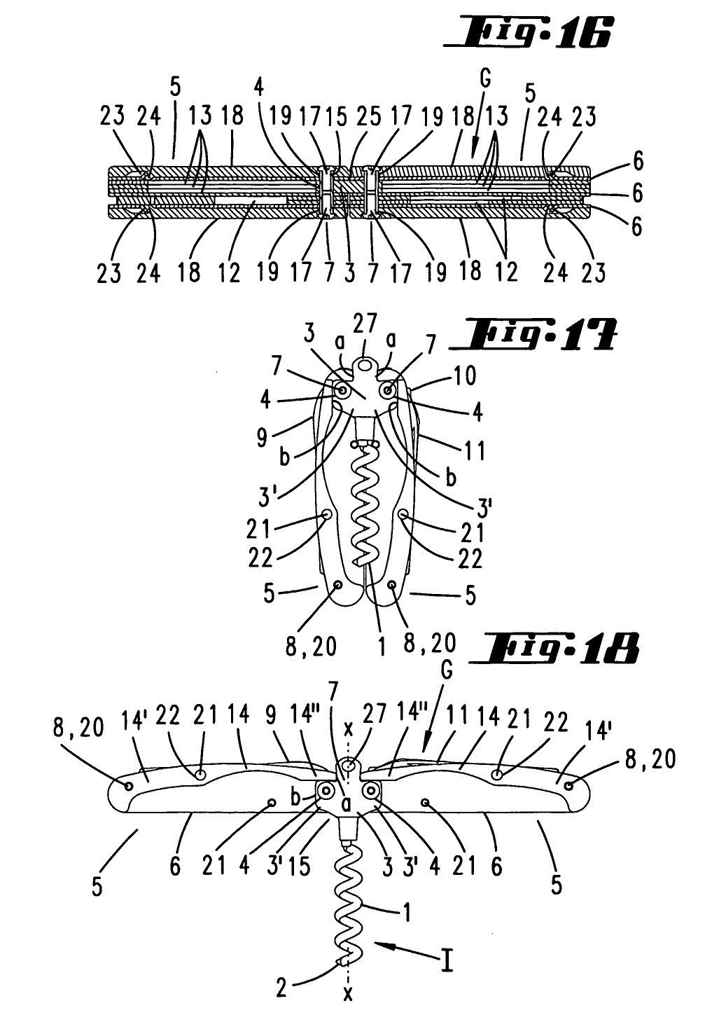

FIG. 15 shows a view from above,

FIG. 16 shows a section on line XVI-XVI in FIG. 11,

FIG. 17 shows the multifunctional tool in partially uncovered form in order to reveal the spring tongues for retaining the grip parts, as seen in the closed position, and

FIG. 18 shows the same in the open position.

The multifunctional tool illustrated, in addition to the actual tool I, also comprises integral additional tool II. The tool I is a corkscrew 1.

At its free end, the corkscrew 1 ends in a sharpened penetration point 2. Its spiral shank merges, in the opposite direction, into a plate-like connecting web 3. The corkscrew 1 is therefore the protruding extension of the connecting web 3.

The connecting web 3, which has lateral wings 3′, provides, in the region of these wings, the bearing eyelet 4 for two grip parts 5 of the multifunctional tool. The grip parts 5 adopt an extended, handle-like profile and have rounded ends at both ends.

The way in which the grip parts 5 are mounted on the connecting web 3 is such that, from a parallel position, as shown for example in FIG. 1, they can only be pivoted into an extended position, as illustrated, for example, in FIG. 3. The extended position, like the parallel position, is limited by stop means.

Once it has been moved into said extended position, the multifunctional tool adopts a configuration which is T-shaped in profile. The cross-grip G, which has limbs which protrude to equal lengths, of the tool which has been moved into the position of use extends substantially perpendicular to the longitudinal center plane x-x of the multifunctional tool, in which the shank of the corkscrew 1 runs. With regard to its actuation, the corkscrew 1 adopts an ergonomically favorable position in the hand.

If, moreover, the additional tools II are also, as illustrated in FIG. 3, folded out of their pivoted-in stowed position into a position of use, in which they are pivoted out through approximately 180°, the lever arms of the cross-grip G are also extended by the length of the additional tools. Since forces exerted flat against the grip parts 5 come into action, it is only the wide faces of the additional tools II which are associated accordingly in a flat position, which are exposed for use. In the event of residual pulling on the cork of a bottle, moreover, the narrow surfaces of these additional tools extend in the back of the cross-grip G of the tool, i.e. remote from the edge 6 of the handle parts 5 beneath which gripping takes place.

In the region of a center-like pivot location 7, in paired form with respect to the bearing eyelets 4, of the multifunctional tool there is a relatively large-area support between the connecting web 3 and the grip parts 5 which are hinged there.

The same also applies with regard to the optionally usable additional tools II which are, as it were, likewise associated in satellite style and in each case pivot about a pin 8 associated with the opposite, free end of the grip part 5 from the pivot location 7.

Additional tools II of this type may be, for example, a pair of scissors 9, a file 10 and/or a cutting blade 11.

In the folded-down position, the additional tools II are accommodated in at least two pockets 12 disposed parallel to one another. These pockets are located between blade leaves 13. The corresponding stowed position can be seen in detail from the drawing, as can the abovementioned grip extension provided by the additional tools II.

The defined parallel position and extended positions, which are each subject to spring forces, of the grip parts 5 are based on elements which have a snap action in the style of a switching device. This is revealed particularly clearly by FIGS. 17 and 18. The core piece of this change-over device is a spring tongue 14. This is realized as a package comprising three spring tongues 14, the foot 14′ of which is fixed to the grip part 5. The head 14″, which is itself resilient, bears powerfully against a control contour which is provided by the connecting web 3, more specifically its two identical wings 3′. The end of the head 14″, which butts against a flank a running parallel to the longitudinal center plane x-x, secures the position of use. The grip parts 5 cannot move into a hyper-extended position. The head 14″ is located under spring load in an angular recess in the connecting web 3. However, the grip parts 5 can be pivoted in the opposite direction. This is done deliberately, with the spring tongue 14 or its head 14″ moving over a stepped edge of the connecting web 3 in order then to be laid resiliently, by means of a head active surface which has likewise moved into the longitudinal center plane x-x, onto the outer flank b adjoining it in stepped form. This retains the grip parts 5 in the parallel position. All this takes place in a pivoting movement about the bearing eyelets 4, more specifically a pin section 15.

There is a pair of pin sections 15 recessed into the connecting web 3 (cf. FIG. 4). It penetrates through the wings 3′. The elements which are associated with one another in stacked form and form the multifunctional tool are fitted onto the ends of the pin sections 15, which project freely on both sides. For this purpose, the elements have matching apertures, denoted by 16 all the way through.

The pin sections 15 have internal screw threads which are open on both sides. Securing screws 17 can be screwed axially into these internal threads. The securing screws 17 pass through grip shells 18 placed onto the outside, so as to close up the sandwich-like or lamellar structure. The way in which said grip shells are fixed is shown particularly clearly in FIG. 16. The heads of the securing screws 17 are positioned in recesses. The aperture which forms the hole for this purpose is denoted by reference numeral 19. The apertures in the remaining elements which form the bearing eyelet 4 are likewise denoted by 19.

By contrast, the pin mounting for the additional tools II is out of sight. The bearing stud for this purpose, the pin 8, penetrates through blade leaves 13, spring tongues 14 and, precisely so as to form a bearing, the hinge locations of the additional tools II. It serves as a rivet 20.

Moreover, a riveted formation is provided for the purpose of securing the foot 14′ of the spring tongue 14. The corresponding rivet is denoted by reference numeral 21 and passes through bores 22 in the blade leaves 13.

To obtain good anchoring between the outer blade leaf 13 and the grip shell 18, an additional anchoring is produced in the vicinity of the rivet 20 which also forms the bearing stud, i.e. in the region of the grip parts 5 which is remote from the pivot location. This is specifically realized by virtue of the grip shells 18, at their free end, being in latched hook engagement with the adjacent blade leaf 13. There is a hook 23 on the blade leaf side. This hook is cut out of the blade leaf material and folded at an angle of 45° toward the pivot location 7. A mating hook 24, which is formed on the underside of the grip shell 18, engages beneath the hook 23 in the opposite direction, utilizing the space which has been cut free. This positively locking latching hook engagement 23/24, which therefore also provides support on the transverse sides, is secured by the sleeve-like pin sections 15 being drawn in.

The pivotably mounted grip parts 5 are in driving engagement with one another, with the result that the corkscrew 1, when the grip parts 5 are being pivoted, is controlled so as to remain in an angle-bisecting position. The control results from toothed engagement of the grip parts 5. For this purpose, a pair of grip shells 18, which are in the same plane, of the two grip parts 5, form toothed segments 25 which project beyond the bearing-side rounding contour of the grip shells 18. The half-thickness of the grip shells which faces the adjoining blade leaf 13 is toothed. The teeth of the meshing toothed segments are substantially trapezoidal in form. The arc of the teeth in each case covers a good quarter-circle. The radius point is the geometric axis of the parallel pin sections 15.

In the parallel position of the grip parts 5, the tool I, i.e. the corkscrew 1, is in practice embedded in a recess. The stowed position in this respect can be seen, for example, from FIG. 1. As can be seen, the penetration point 2 is likewise recessed into the edge protection, so that the multifunctional tool in question can be carried along as a pocket tool without danger.

This protective measure is achieved in a functionally reliable manner using structurally simple means by virtue of the fact that each of the two grip parts 5 forms a half-pocket 26 on sides which face one another with regard to the folding action. In the parallel position of the grip parts 5, these half-pockets 26 complement one another to form a pocket T which accommodates the corkscrew 1 by tightly surrounding it. The depth of the pocket T, measured in the thickness direction of the multifunctional tool, takes full account of the external diameter of the spiral shank of the corkscrew 1. Blade leaves 13 and the spring package are also incorporated in the corresponding opening-out all the way to the center of the multifunctional tool. FIG. 16 clearly shows the corresponding clear space. It is also possible to recognize an overlapping disposition of the functional parts in the stowed position. The corkscrew 1 and the spring tongues 14 for retaining the grip parts 5 are accommodated in an upper level; the additional tools are located in a lower level.

The division of space is revealed by FIGS. 12 and 13. As can be seen, the inner side of the connecting web 3 ends in the center of the cross section y-y of the tool. The spiral shank of the corkscrew 1 eccentrically adjoins the significantly thinner connecting web 3, with a perceptible outward offset to the right-hand side.

An eye 27 is provided for the connecting web 3, so as to continue the flank a, in the longitudinal center plane x-x, in order to enable the multifunctional tool to be secured to a carrying chain or the like.

With regard to the spring-loaded pivoted-out position and the spring-loaded pivoted-in position, limited by stop means, of the additional tools II, such as scissors 9, file 10 and/or cutting blade 11, these defined limit positions are achieved in the same way as the retaining of the grip parts 5 on the connecting web 3. In this case, however, the control link is that section of the additional tool tail 28 which is hinged about the bearing stud, i.e. rivet 8, and a spring tongue 29 which interacts therewith. The spring tongue is likewise anchored on the foot side. It is held captively by means of the rivet 21 and a hook jaw 30 which is supported on the pin section 15.

All features disclosed are (inherently) pertinent to the invention. The content of disclosure of the associated/appended priority documents (copy of the prior application) is hereby incorporated in its entirety in the disclosure of the application, partly with a view to incorporating features of these documents in claims of the present application.

I claim:

1-12. (canceled)

13. Multifunctional tool assembly comprising: two grip parts (5), which face one another and are pivotable about a pivot out of a parallel position; stop means, and a corkscrew (1) arranged in a region of the pivot (7), it being possible for the two grip parts (5), from the parallel position, to be pivoted into an extended position, with a pivoting movement being limited by the stop means; wherein the corkscrew (1), when the grip parts (5) are being pivoted, is controlled by two toothed segments so as to remain in an angle-bisecting position by the two toothed segments (25); and the two toothed segments mesh with one another and are each associated with one of the two grip parts (5), and each segment is an extension of a connecting web (3) which carries the two grip parts (5) in such a manner as to connect them to one another.

14. Multifunctional tool assembly according to claim 13, further comprising grip shells, wherein the toothed segments (25) are formed each by a grip shell (18).

15. Multifunctional tool assembly according to claim 13, further comprising spring tongues (14) which engage on the connecting web (3) in order to retain the grip parts (5) in the parallel and extended position.

16. Multifunctional tool assembly according to claim 13, further comprising at least two pockets, and pin sections (15) which are associated with the connecting web (3) and connect to one another the at least two pockets (12), which are disposed parallel to one another, for blade leaves (13) forming the additional tools (II) which can be pivoted out.

17. Multifunctional tool assembly according to claim 16, further comprising securing screws (17) screwed into the pin sections (15) in order to fix the two grip shells (18).

18. Multifunctional tool assembly according to claim 14, wherein an individual one of the grip shells (18), at its respective free end, is connected to one of a plurality of blade leaves (13) with a latching hook engagement (23/24).

19. Multifunctional tool assembly according to claim 13, wherein each of the two grip parts (5) forms a half-pocket (26), and in the parallel position of the grip parts (5) these half-pockets complement one another to form a pocket (T) which accommodates the corkscrew (1).

20. Multifunctional tool assembly according to claim 13, wherein the pocket (T) is located eccentrically.

21. Multifunctional tool assembly according to claim 13, further comprising additional tools (II) located at outer ends of the grip parts (5) and consisting essentially of a pair of scissors (9), a file (10) and/or a cutting blade (11).
